(19) United States
(12) Patent Application Publication
(10) Pub. No.: US 2009/0159637 A1
(43) Pub. Date: Jun. 25, 2009

(54) STAPLER HAVING POWER MUTLIPLYING MECHANISM

(75) Inventor: Jun Maemori, Tokyo (JP)

Correspondence Address: DRINKER BIDDLE & REATH (DC), 1500 K STREET, N.W., SUITE 1100, WASHINGTON, DC, 20005-1209, US

(73) Assignee: Max Co., Ltd., Tokyo (JP)

(21) Appl. No.: 12/089,946

(22) PCT Filed: Nov. 2, 2006
(86) PCT No.: PCT/JP2006/322407

§ 371 Date: Apr. 11, 2008

(30) Foreign Application Priority Data
Nov. 9, 2005 (JP) 2005-324583

(51) Int. Cl. B27F 7/17

(52) U.S. Cl. 227/120

(57) ABSTRACT

A stapler includes a base, a first support portion disposed on the base, a support plate formed in the vicinity of the first support portion on each side of the base, a second support portion formed on the support portion so as to project therefrom, a staple storing magazine and an inner handle, both provided swingably on the first support portion, a driver plate disposed on the inner handle so as to strike out a staple, and an outer handle provided swingably on the second support portion. The outer handle includes a first handle member having a first half hole portion engageable with an upper portion of the two second support portion, and a second handle member having a second half hole portion engageable with a lower portion of the second support portion. The first handle member and the second handle member are connected integrally.

### TECHNICAL FIELD

The present invention relates to a stapler having a power multiplying mechanism.

### BACKGROUND ART

Japanese Patent Unexamined Publications 2005-138248 (Page 9, FIG. 2) and 2005-138247 (Page 4, FIG. 2) disclose a large-sized stapler having an outer handle and an inner handle, in which these outer and inner handles can be swung about their respective end portion swing fulcrums shifted in position from each other in the back-and-forth direction of the stapler, and the outer and inner handles can be operated interlockingly through a connecting member thereby providing a power multiplying mechanism. By making use of a power multiplying effect provided by the power multiplying mechanism, a handle operation force applied in the sheet binding operation can be reduced and the sheet binding operation can be facilitated.

By the way, with regard to the fulcrum of the swing support portion of the outer handle of the above-mentioned large-sized stapler having a power multiplying mechanism, as a swing support shaft thereof, there is used a stepped pin and also, in order to prevent the stepped pin against removal, there is used an E retaining ring. However, use of the stepped pin as the swing support shaft in the swing fulcrum and use of the E retaining ring for prevention of removal of the stepped pin not only increase the number of parts to thereby increase the cost of the parts but also increase the time necessary to assemble the parts together to thereby incur an increase in the part assembling cost.

Also, the outer handle of the above-mentioned large-sized stapler is provided as an single structure and is made of a single metal sheet, and the engaging portion of the outer handle to be engaged with the pin member for constitution of a linking mechanism with respect to the inner handle, that is, the groove portion side edge of the arc-shaped groove portion of the outer handle is burring worked to gain the sheet thickness so as to be able to stand a high load. However, when a high load is applied to the thus burring worked groove portion side edge for a long period, the groove portion side edge is shaved or worn to be thereby deformed, which causes the linking mechanism to wobble and thus obstructs the smooth operation of the linking mechanism, resulting in the lowered durability of the stapler.

In view of the above, there can be expected a heat treatment for prevention of the above-mentioned deformation of the groove portion side edge due to the shaving and wearing. However, when a relatively large part such as the outer handle is heat treated, the cost thereof increases and, therefore, it is difficult to employ such heat treatment measure from the viewpoint of the price of the product. Also, a measure using a heat treatment enforced on a partial portion of a part results in an increase in the cost of the part from the viewpoint of the technical aspect and operation efficiency aspect of the part.

### DISCLOSURE OF THE INVENTION

One or more embodiments of the present invention provides a stapler having a power multiplying mechanism, in which a manufacturing cost is reduced and a durability is enhanced.

According to one or more embodiments of the invention, a stapler includes a base having a clinch groove, a first support portion disposed on one end of the base, a support plate formed on the base in the vicinity of the first support portion so as to rise up from each side of the base, a second support portion formed on the support portion so as to project therefrom in a tube-shape, a staple storing magazine provided swingably on the first support portion, an inner handle provided swingably on the first support portion, a driver plate disposed on the inner handle so as to strike out a staple toward the clinch groove, and an outer handle provided swingably on the second support portion. The outer handle includes a first handle member having a first half hole portion engageable with an upper portion of the two second support portion, and a second handle member having a second half hole portion engageable with a lower portion of the second support portion. The first handle member and the second handle member are connected integrally.

According to one or more embodiments of the invention, the stapler may further include a pin member, and the second handle member may include side plates, each having a guide groove formed in the vicinity of the second support portion, wherein the pin member engages with the guide groove and the inner handle.

According to one or more embodiments of the invention, the second handle member may be formed shorter than the first handle member and may be hardened by heat treatment.

According to one or more embodiments of the invention, the guide groove may be formed in a S-shape.

According to one or more embodiments of the invention, the pin member may be a single pin member which extends between the side plates.

According to one or more embodiments of the invention, a distance between the first support portion and the pin member may be longer than a distance between the second support portion and the pin member.

According to one or more embodiments of the invention, the second support portion may be formed by a burring work so as to project in a short tube-shape.

According to one or more embodiments of the invention, the second handle member may be connected to the first handle member such that the second handle member is superimposed inside the first handle member.

According to one or more embodiments of the invention, the first handle member may have a projecting piece, and the second handle member may have a hole portion, wherein the projecting piece is fitted into the hole portion.

According to one or more embodiments of the invention, the stapler may further include a pin, wherein the first handle member and the second handle member are connected integrally with the pin inserted through a hole formed on each of the first and the second handle member.

According to one or more embodiments of the invention, the stapler is structured such that the support plate is formed on the base so as to rise up from the each side of the base, on which the tube-shaped second support portion is formed projectingly by burring work, and such that the first handle member having a first half hole portion engageable with an upper portion of the two second support portion and the second handle member having a second half hole portion engageable with a lower portion of the second support portion are connected integrally, thereby providing the outer handle that is swingably supported. Therefore, a bearing portion of the outer handle can be formed by assembling the first and second handle members together with the tube-shaped second support portions in such a manner that the two half hole portions hold the second support portion therebetween. Consequently, the operation for mounting the outer handle onto the second support portions can be carried out easily.

Also, according to one or more embodiments of the invention, since the second support portion is formed by burring work, a stepped pin for the swing support portion or an E retaining ring for prevention of removal of the stepped pin is not necessary. This not only can reduce the number of parts but also can reduce the time and labor for mounting the parts, which provides an advantage in the cost of the stapler.

Further, according to one or more embodiments of the invention, the guide groove is formed on the side plate of the second handle member in the vicinity of the second support portion, and the pin member is engaged with the guide groove and the inner handle, thereby driving the inner handle when an end portion of the outer handle is pressed down in a binding direction. This structure provides a power multiplying mechanism in which the second support portion functions as a fulcrum, the engaging portion between the guide groove, pin members and inner handle function as am operation point, and the end portion of the first handle member functions as a force point, whereby a distance ratio between the operation point and force point with respect to the fulcrum is large. This power multiplying mechanism can reduce an operation force for striking the staples when binding the bunch of sheets together and, therefore, it is possible to provide a stapler which is easy to use.

According to one or more embodiments of the invention, the second handle member is hardened by heat treatment. As described above, when the first handle is swung, owing to the power multiplying mechanism, a high load is applied from the pin member to a side edge of the guide groove of the second handle member. However, since the second handle member is thermally hardened, even when the second handle member is used repeatedly, the side edge of the guide grooves, with which the pin members are engaged, are hard to be deformed or damaged due to shaving or wearing. This can restrict the rickety motion of the handle when it is swung. As a result of this, the smoothness, stability and reliability of the operation of the handle can be secured as well as there can be provided a stapler which is excellent in durability.

Also, because the second handle member is formed shorter than the first handle member, the cost necessary for the heat treatment of the second handle member can be reduced.

### BRIEF DESCRIPTION OF THE DRAWINGS

FIG. 1 is a perspective view of the external appearance of a stapler according to an embodiment of the invention, when it is viewed from obliquely ahead.

FIG. 2 is a perspective view of the external appearance of a stapler according to the embodiment of the invention, when it is viewed from obliquely behind.

FIG. 3 is a side section view of the main structure portions of a stapler according to the embodiment of the invention, showing a stand-by state thereof.

FIG. 4 is a view of a stapler according to the embodiment of the invention, showing one of the states thereof in its handle pushing-in operation, that is, a state in which a power multiplying mechanism is in operation.

FIG. 5 is a view of a stapler according to the embodiment of the invention, showing one of the states thereof in its handle pushing-in operation, that is, a clinching state thereof.

FIG. 6 is a view of a stapler according to the embodiment of the invention, showing a handle open state thereof.

FIG. 7 is a partial view of the main structure portions of the embodiment of the invention.

FIG. 8 is a partial view of the main structure portions of the embodiment of the invention, that is, a section view taken along the line X-X shown in FIG. 7.

FIG. 9 is a view of the structural parts of the main structure portions of the embodiment of the invention.

FIG. 10 is a view of the main structure portions of the embodiment of the invention.

FIG. 11 is a section view taken along the line Y-Y shown in FIG. 10.

FIG. 12 is a view of another embodiment of the section view taken along the line Y-Y shown in FIG. 10.

### BEST MODE FOR CARRYING OUT THE INVENTION

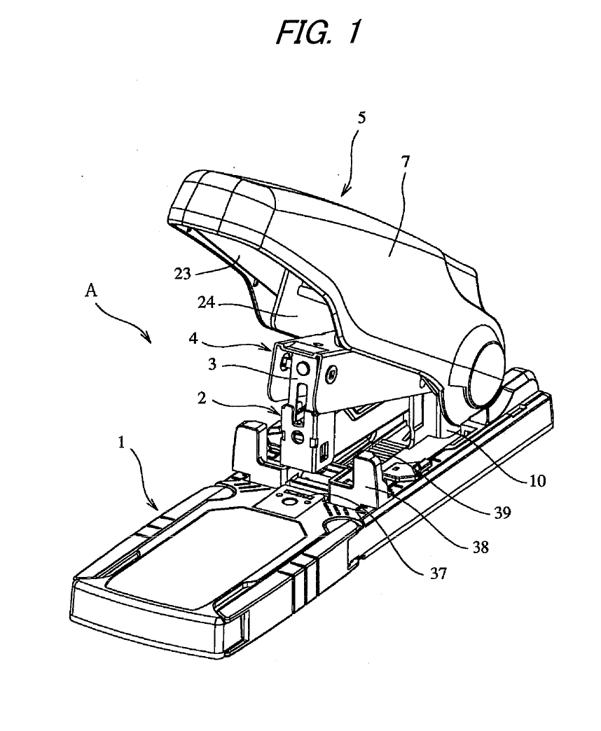

Now, description will be given below of an embodiment according to the invention with reference to FIGS. 1 to 12.

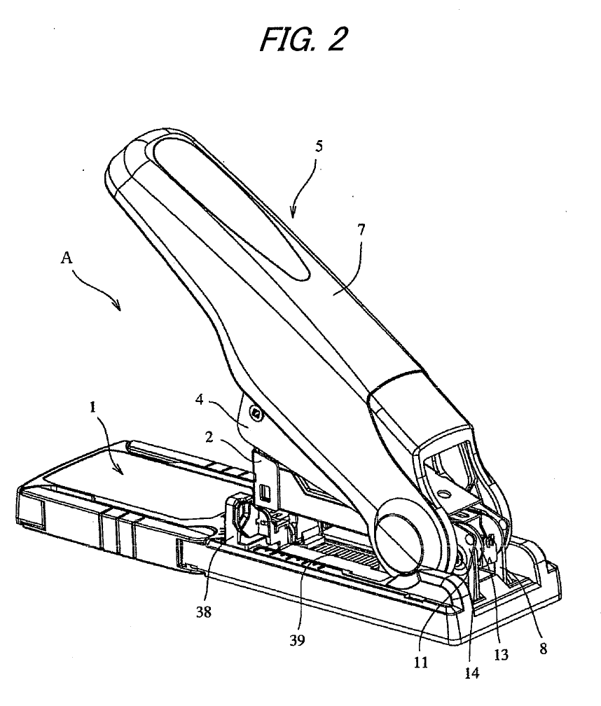

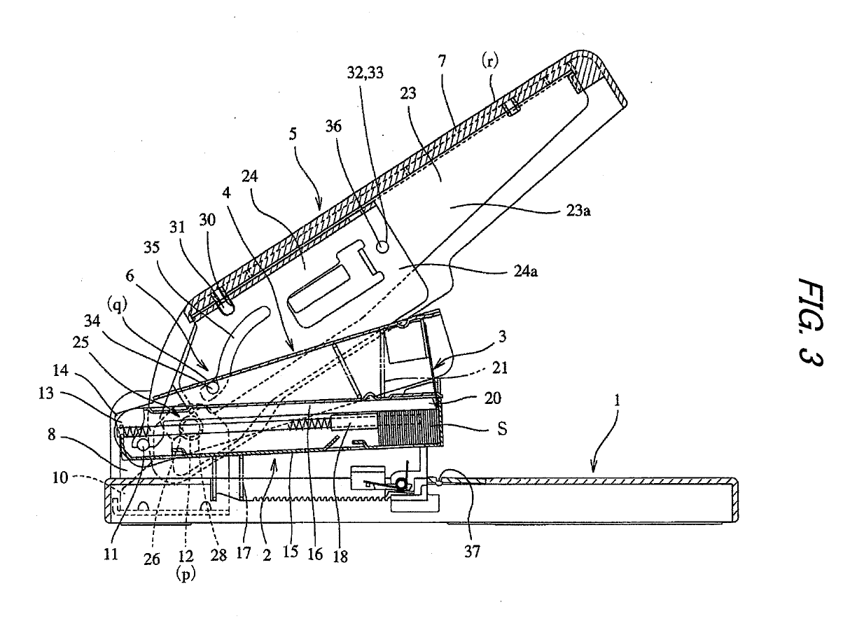

A stapler A according to the invention, as shown in FIGS. 1 and 2, comprises a base 1, a magazine 2 for storing staples S (see FIG. 3) therein, an inner handle 4 including a driver plate 3 for striking the staples S stored in the magazine 2 out of the magazine 2, an outer handle 5 for applying a striking operation force for binding bunch of sheets together to the driver plate 3 through the inner handle 4, a linking mechanism 6 (see FIG. 3 and the like) for operating the inner handle 4 and outer handle 5 in linking with each other, and the like, while the outer handle 5 is structured such that the entire surfaces of the outer surface portions thereof, that is, the upper and side portions thereof are covered with a handle cover 7 which is a resin cover member.

Referring to the structure of the base 1, as shown in FIG. 3 as well, in the rear portion thereof (in FIG. 3, on the left side), there are provided two first support portions 11 respectively formed in two metal-made support plates 8 which are respectively structured so as to rise up from the two sides of the rear end portion (in FIG. 3, the left end portion) of the base 1; in another support plates 10, there are formed two second support portions 12 in such a manner that they respectively rise up from their associated support plates 10; and, the second support portions 12 are set slightly forward (in FIG. 3, rightward) of the first support portions 11 in the back-and-forth direction of the longitudinal direction of the base 1.

On the first support portions 11, there are swingably supported the respective rear base end portions 13 and 14 of the magazine 2 and inner handle 4.

The magazine 2, as shown in FIG. 3, includes a channel-shaped member 15 of a given length and a staple cover 16 for covering the upper portion of the channel-shaped member 15 in such a manner that the channel-shaped member upper portion can be freely opened and closed; and, the channel-shaped member 15 is made of a metal sheet material such as a steel plate, is bent in a substantially upward facing U shape when it is viewed from the section thereof, and includes closed front and rear end portions. And, the magazine 2 is swingably energized upwardly by a return spring 17 which is interposed between the magazine 2 and base 1 at a position slightly near to the rear side of the central portion of the lower portion of the channel-shaped member 15.

Within the magazine 2, there are loaded connected staples S, and the thus-loaded staples S are energized by the staple pusher 18 toward a strike-out portion 20 formed in the leading end portion of the magazine 2.

On the leading end portion of the inner handle 4, as described before, there is mounted the driver plate 3 which is used to strike the staples S for binding the bunch of sheets together.

The inner handle 4 is energized upwardly by a return spring 21 interposed between the inner wall upper portion of the inner handle 4 existing slightly backward of the leading end portion thereof and the upper portion of the magazine 2 slightly backward of the leading end portion thereof, whereby, when the staples S striking operation force is removed after binding the bunch of sheets, the inner handle 4 can be swung upwardly, that is, counterclockwise with the above-mentioned first support portions 11 as the swing fulcrum thereof.

Next, on the second support portions 12 of the support plates 10 provided on the base 1 in such a manner that they respectively rise up from the base 1, there is supported the outer handle 5 in such a manner that it can be swung freely.

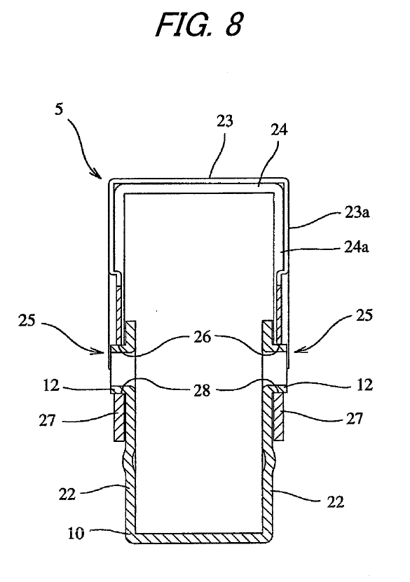

The support plates 10, as shown in FIG. 8, are respectively formed to have a substantially upwardly facing U shape when it is viewed from the section thereof, while the second support portions 12 are formed on the two side plates 22 of the support plates 10 such that they respectively project in a short tube shape from the two side plates 22. The second support portions 12 are respectively formed by burring work the support plates 10.

The outer handle 5, as shown in FIG. 3, is structured by connecting together a long first handle member 23 and a short second handle member 24, which is fitted with and fixed to the inside of the first handle member 23, to thereby provide a unified body; and, in the rear base end portion of the outer handle 5, there are formed the bearing portions 25 of the second support portions 12 which are used to swing and support the outer handle 5.

Next, description will be given below in detail of the outer handle 5.

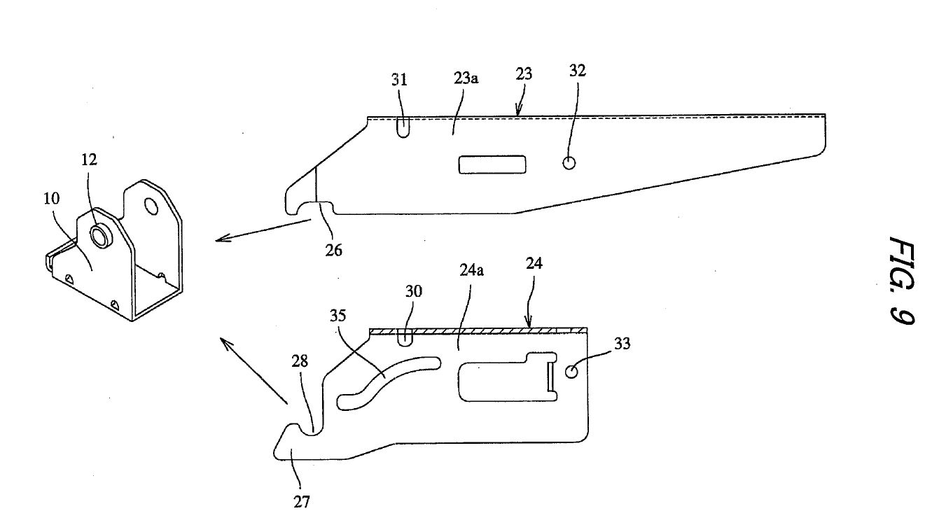

That is, the first handle member 23, as can be understood with reference to FIG. 3 and FIG. 9 which shows the parts of the outer handle 5 separately, is made of a long member produced by bending a metal sheet material such as a steel plate into a substantially downward facing U shape when it is viewed from the section thereof; and, the surface of the outer portion of the first handle member 23 is covered with the resin cover member 7, and the first handle member 23 has a length double the length of each of the inner handle 4 and magazine 2. Also, in the rear base end portions of the two side plates 23a of the first handle member 23, there are formed cut-out portions defining half hole portions 26 which can be engaged with the upper portions of the second support portions 12, while the half hole portions 26 are elongated holes the bottom sides of which are parallel to each other and the half hole portions 26 are opened downward.

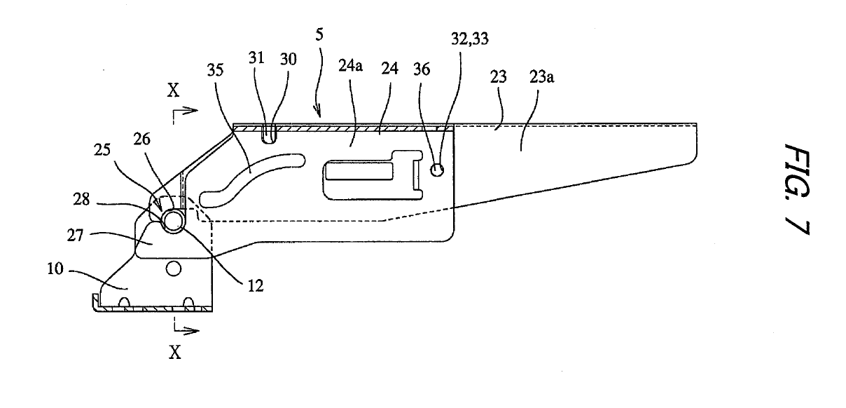

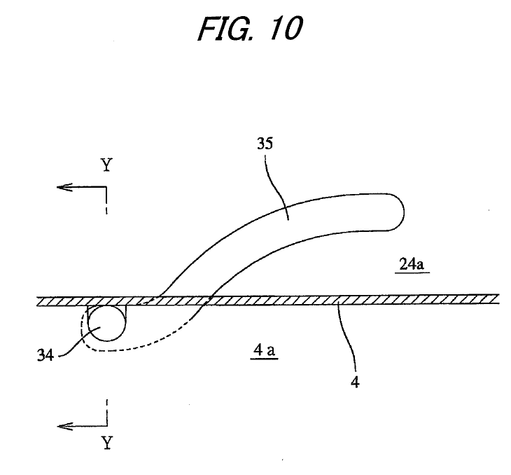

The second handle member 24, as described above and also as can be understood with reference to FIGS. 7 and 8 as well as FIGS. 9 and 10 which show the parts separately, includes a member slightly larger in thickness than the first handle member 23 and is produced by bending a metal sheet material such as a steel plate into a substantially downward facing U shape when it is viewed from the section thereof, while the second handle member 24 has a length substantially half the length of the first handle member 23 but is higher than the first handle member 23. Also, the upper outer portion of the second handle member 24 has a shape which can be closely fitted with the inside of the rear half portion of the first handle member 23. Further, in the two side plate portions 27 of the second handle member 24 which are respectively extended downwardly backward of the two side plates 24a, there are formed arc-shaped half hole portions 28 which can be engaged with the upper portions of the second support portions 12.

The above-mentioned first and second handle members 23 and 24 are connected integrally into a unified body, thereby constituting the outer handle 5. That is, the lower half hole portions 28 of the rear base end portions of the second handle member 24 are engaged with the outer peripheral lower portions of the second support portions 12 from below and, at the same time, the upper half hole portions 26 of the rear base end portions of the first handle member 23 are engaged with the outer peripheral upper portions of the second support portions 12 in such a manner that the former is fitted with the latter from outside the second handle member 24. Further, a hole portion 30 formed in the upper wall portion of the second handle member 24 is fitted with a projecting piece 31 provided by cutting and raising a portion of the top wall of the first handle member 23, and pins 36 are inserted into hole portions 32 and 33 respectively formed in the first and second handle members 23 and 24. Owing to these operations, the first and second handle members 24 are disposed respectively outside and inside, are also superimposed on top of each other, and are thus connected together to provide a unified body, thereby constituting the outer handle 5.

As described above, the outer handle 5 has a two-division structure composed of the first and second handle members 23 and 24, while the bearing portions 25 of the outer handle 5 can be formed by assembling the two half hole portions 26 and 28 of the first and second handle members 23 and 24 together with the short-tube-shaped second support portions 12 in such a manner that the half hole portions hold the second support portions 12 by and between them from above and from below.

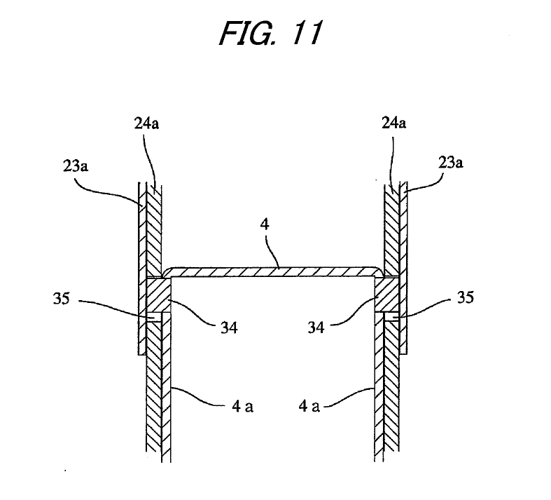

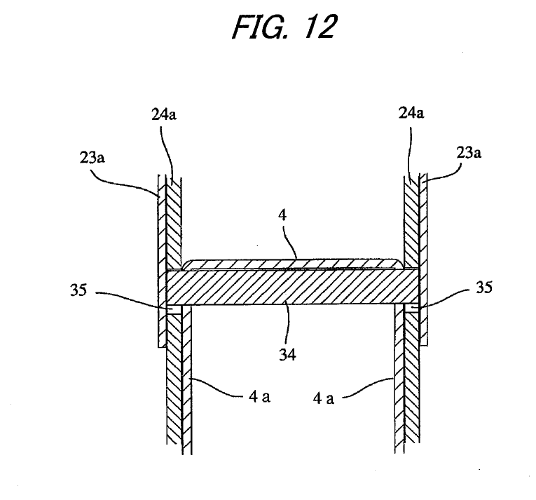

Also, the inner and outer handles 4 and 5 are linked with each other through the linking mechanism 6. As shown in FIGS. 10 and 11, on the two side plates 4a of the inner handle 4, there are provided pin members 34 at positions respectively in front of their associated first support portions 11. As shown in FIG. 11, these pin members 34 are provided as separate split pins on the upper portions of the above-mentioned two side plates 4a existing slightly forward (in FIG. 11, rightward) of the first support portions 11 that are the swing support portions of the inner handle 4. By the way, the pin members 34, which are split formed on the upper portions of the two side plates 4a of the inner handle 4, as shown in FIG. 12, may also be structured as a single pin member 34 which extends between and over the two side plates 4a.

On the other hand, in such portions of the two side plates 24a of the second handle member 24 that exist slightly forward of the lower half hole portions 28, there are formed guide grooves 35 respectively. These guide grooves 35 are respectively formed as an S-shaped groove which extends forwardly and slightly upwardly while it is curved gently. And, into the guide grooves 35, there are engaged the pin members 34 which are provided on the two sides of the inner handle 4. This constitutes the linking mechanism 6 which defines an operational connecting relationship between the outer handle 5 and inner handle 4.

Also, according to the structure of the above-mentioned linking mechanism 6, as will be discussed later in detail, there is secured a relatively large distance between the pin 34 and the first support portion 11 that functions as the swing center of the inner handle 4, while the pin members 34 are engaged with the guide grooves 35 at positions quite near to the second support portions 12 which function as the swing center of the outer handle 5. Thus, the second support portions 12 function as a fulcrum p, the engaging portion between the pin member 34 and guide groove 35 functions as an operation point q, and the end portion of the first handle member 23 to which the force is applied functions as a point of force r, thereby constituting a power multiplying mechanism which can provide a large distance ratio between the operation point q and force point r with respect to the fulcrum p.

By the way, as shown in FIG. 1, substantially in the central portion of the base 1, there is formed a clinch groove 37 at a position which corresponds to the leading end of the magazine 2. Also, in the rear of the clinch groove 37, there is disposed a gauge member 38 for positioning the bunch of sheets to be bound in such a manner that it can be slided along scale grooves 39 formed in the base 1. The gauge member 38 is structured such that, when it is secured to the proper one of the scale grooves 39, it can be stopped there.

Next, the sheet binding operation by the above-structured stapler is carried out according to the following procedures and operations.

Firstly, a bunch of sheets to be bound (not shown) is placed onto the base 1 of the stapler A which is held in its stand-by state shown in FIG. 3, the end portions of the bunch of sheets are applied to the gauge (see FIG. 1), the sheet end binding position is adjusted and set, the bunch of sheets are held fast, and an operation force for striking the staples S is applied to the operation portion of the front end portion of the outer handle 5, so that the outer handle 5 is pushed down.

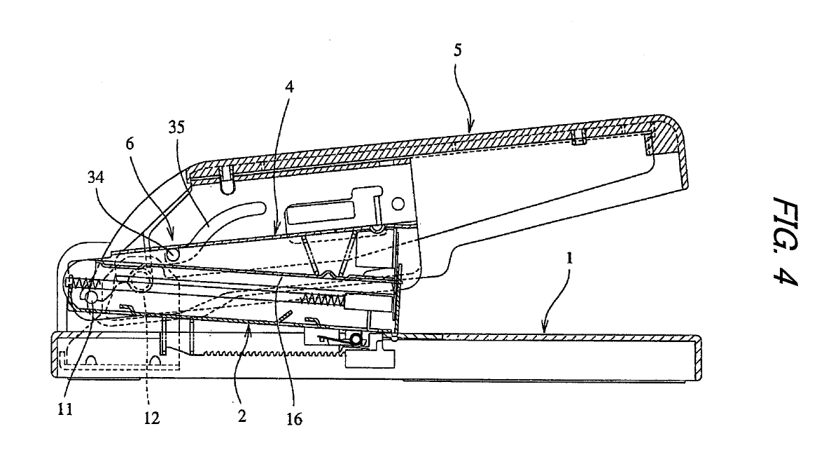

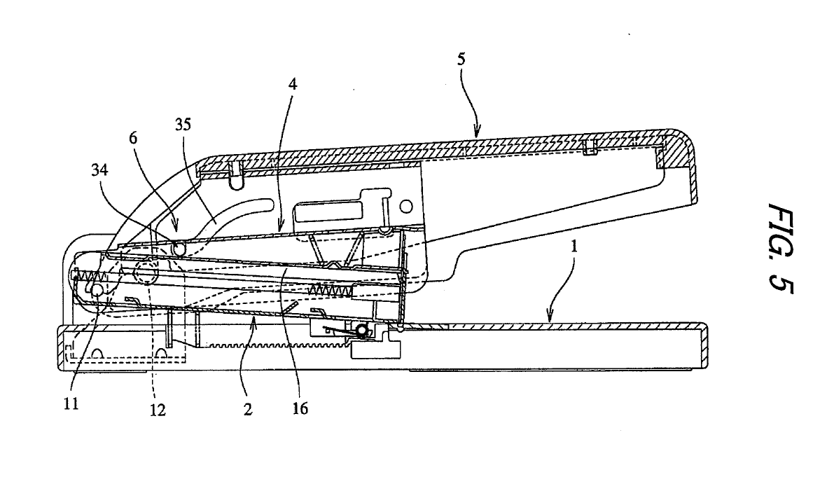

As the outer handle 5 is pushed down, the outer handle 5 is swung with the second support portions 12 as its swing fulcrum, and the striking operation force of the outer handle 5 is transmitted to the inner handle 4 through the pin members 34 engaged with the arc-shaped guide grooves 35 of the outer handle 5, whereby the inner handle 4 is swung with the first support portions of the rear base end portions 14 of the inner handle 4 as its swing fulcrum. At the then time, as described above, since the distance ratio between the engaging portion (which functions as the operation point q) of the guide groove 35, the pin member 34 and inner handle 4, and the end portion (which functions as the force point r) of the first handle member 23 with respect to the second support portions 12 (which function as the support point p) is large, the present power multiplying mechanism is able to apply a large drive force to the inner handle 4 (see FIG. 4). Therefore, the staples S within the magazine 2 are struck out of the strike-out portion 20 with a small operation force and are penetrated through the bunch of sheets to be bound, and are further bent by the clinch groove 37, and the sheet binding operation finishes (see FIG. 5).

After end of the binding operation, the striking operation force of the outer handle 5 is removed, whereby the magazine 2 and inner handle 4 are swung counterclockwise, that is, upwardly with the first support portion 11 thereof as the swing fulcrum due to the energizing forces of the return springs 17 and 21.

The upward swinging motion of the inner handle 4 with the first support portions 11 thereof as the swing fulcrum, simultaneously with it, also causes the upward swinging motion of the outer handle 5 with the second support portions 12 as the swing fulcrum thereof. This series of motion returns the magazine 2, inner handle 4 and outer handle 5 respectively to their initial stand-by states (see FIG. 3).

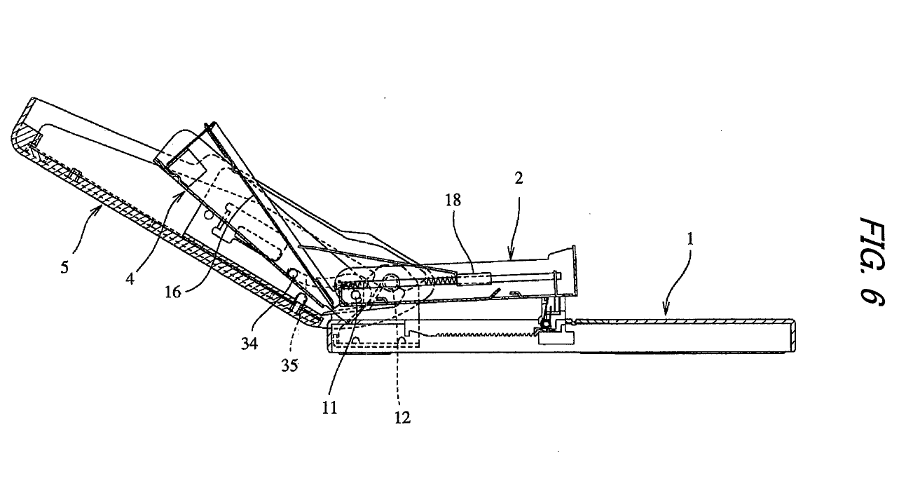

By the way, to load the staples S into the magazine 2 for filling up the shortage of the staples S, the outer handle 5 and inner handle 4 may be opened as shown in FIG. 6 and, at the same time, the staple cover 16 may also be opened in linking with the opening operation of the outer and inner handles 5 and 4. Further, the staple pusher 18 may also be moved backward. In this open state, the connected staples S may be loaded into the magazine 2. At the then time, although the pin members 34 are respectively moved up to the end portions of their associated guide grooves 35, since the guide grooves 35 are respectively formed as a gently curved S-shaped groove, the swing speed of the inner handle 4 is even and the load of the inner handle 4 while swinging is applied to the outer handle 5 evenly, whereby the staples S filling operation can be carried out with a high operation efficiency.

According to the above-mentioned stapler, there can be obtained the following effects.

Thanks to employment of the above power multiplying mechanism, the staple striking operation force applied to the outer handle 5 in the sheet binding operation can act on the inner handle 4 in an increased manner. This can reduce the staple striking operation force in the sheet binding operation, with the result that there can be obtained a stapler A which is easy to use.

Because the second support portions 12 are projectingly formed as short-tube-shaped portions by burring work the two support plates 10 which respectively rise up from the two sides of the base 1, stepped pins and E retaining rings are not necessary, thereby being able to reduce the costs of the parts and the parts assembling costs.

Since the bearing portions 25 of the outer handle 5 are formed by assembling together the short-tube-shaped second support portions 12 and the first and second handle members 23 and 24 in such a manner that the two half hole portions 26, 28 hold the second support portions 12 between them from above and from below, the operation for assembling the first and second handle members 23 and 24 to the second support portions 12 is simple and takes only a short time to complete.

Next, although a high load is applied to the guide grooves 35 of the second handle member 24 by the pin members 34, when the second handle member 24 is heat treated (quenched) after end of the mechanical working thereof and the like, the strength of the second handle member 24 can be enhanced and thus the durability of the second handle member 24 can be enhanced. Also, since the second handle member 24 may be smaller than the first handle member 23, it is easy to heat treat the second handle member 24 and the cost thereof is not so high. On the other hand, although the first handle member 23 is larger than the second handle member 24, since a large load is not applied to the first handle member 23, it can be made of a steel plate or a similar metal plate having a relatively small thickness; and, because it is not necessary to quench the first handle member 23, it can be made of a metal sheet material such as a steel plate having a relatively small thickness. Therefore, there can be provided an outer handle 5 having the desired strength and durability, while restricting an increase in the cost of the outer handle 5 and an increase in the weight thereof.

By the way, since the second handle member 24 including the guide grooves 35 to which a high load is applied is heat treated, the abrasion resistance of the second handle member 24 including the guide grooves 35 is enhanced and thus, even when the second handle member 24 is used repeatedly, the deformation or damage of the groove portion side edges of the guide grooves 35 with which the pin members 34 are engaged due to the wear or shaving thereof can be restricted or prevented. Therefore, when the handle is swung, the rickety motion of the handle can be restricted, which not only can secure the smoothness, stability and reliability of the handle operation but also can provide a stapler A excellent in durability.

While there has been described in connection with the preferred embodiments of the present invention, it will be obvious to those skilled in the art that various changes and modification may be made therein without departing from the present invention. It is aimed, therefore, to cover in the appended claim all such changes and modifications as fall within the true spirit and scope of the present invention.

The subject patent application is based on a Japanese patent application No. 2005-324583 filed on Nov. 9, 2005, the content of which is incorporated herein by reference.

### INDUSTRIAL APPLICABILITY

In a stapler having a power multiplying mechanism, a manufacturing cost can be reduced and a durability can be enhanced.

1: A stapler having a power multiplying mechanism, comprising:
a base having a clinch groove;
a first support portion disposed on one end of the base;
a support plate formed on the base in the vicinity of the first support portion so as to rise up from each side of the base;
a second support portion formed on the support plate so as to project therefrom in a tube-shape;
a staple storing magazine provided swingably on the first support portion;
an inner handle provided swingably on the first support portion;
a driver plate disposed on the inner handle so as to strike out a staple toward the clinch groove; and
an outer handle provided swingably on the second support portion,
wherein the outer handle comprises:
a first handle member having a first half hole portion engageable with an upper portion of the second support portion; and
a second handle member having a second half hole portion engageable with a lower portion of the second support portion;
wherein the first handle member and the second handle member are connected integrally.

2: The stapler according to claim 1, further comprising:
a pin member,
wherein the second handle member includes side plates, each having a guide groove formed in the vicinity of the second support portion, and
the pin member engages with the guide groove and the inner handle.

3: The stapler according to claim 2, wherein the second handle member is formed shorter than the first handle member and is hardened by a heat treatment.

4: The stapler according to claim 2, wherein the guide groove is formed in a S-shape.

5: The stapler according to claim 2, wherein the pin member is a single pin member which extends between the side plates.

6: The stapler according to claim 2, wherein a distance between the first support portion and the pin member is longer than a distance between the second support portion and the pin member.

7. The stapler according to claim 1, wherein the second support portion is formed by a burring work so as to project in a short tube-shape.

8: The stapler according to claim 1, wherein the second handle member is connected to the first handle member such that the second handle member is superimposed inside the first handle member.

9: The stapler according to claim 1, wherein the first handle member has a projecting piece, and the second handle member has a hole portion, wherein the projecting piece is fitted into the hole portion.

10: The stapler according to claim 1, further comprising a pin, wherein the first handle member and the second handle member are connected integrally with the pin inserted through a hole formed on each of the first and the second handle member.
